(19) United States
(12) Patent Application Publication
(10) Pub. No.: US 2009/0101224 A1
(43) Pub. Date: Apr. 23, 2009

(54) Joint and joining method for multilayer composite tubing and fittings

(75) Inventor: Christopher G. Ziu, Lenexa, KS (US)

Correspondence Address: EDWARDS ANGELL PALMER & DODGE LLP, P.O. BOX 55874, BOSTON, MA, 02205, US

(73) Assignee: Orion Enterprises, Inc., Kansas City, KS (US)

(21) Appl. No.: 12/288,274

(22) Filed: Oct. 17, 2008

Related U.S. Application Data
(60) Provisional application No. 60/980,583, filed on Oct. 17, 2007.

(51) Int. Cl. B23P 11/00; F16L 11/04; F16L 41/00; F16L 43/00; F16L 23/00

(52) U.S. Cl. 138/109; 138/137; 29/428; 285/125.1; 285/179; 285/405; 138/141; 138/120; 138/155

(57) ABSTRACT

A joining method wherein ends of multilayer composite tubing and/or fittings having at least one middle layer of malleable metal are flared radially outwardly so that exposed ends of the middle layer of malleable metal are directed radially outward and away from a fluid flow path within the tubing and/or fittings. The flared-out ends are then fused using infrared butt welding so that the resulting bead protrusion into the fluid flow path is small enough to be acceptable for use in a high purity water system.

### CROSS-REFERENCE TO RELATED APPLICATION

This application claims priority to U.S. Provisional Patent Application No. 60/980,583, filed Oct. 17, 2007, which is incorporated herein by reference. This application is related to International Application No. PCT/US2007/007686 (Atty. Docket No. 65978PCT), which claims priority to U.S. Provisional Patent Application No. 60/744,212, filed Apr. 4, 2006, both of which are incorporated herein by reference.

### TECHNICAL FIELD OF THE DISCLOSURE

The present disclosure relates to a joint and joining method for multilayer composite tubing and fittings having at least one middle layer of malleable metal. The joint and joining method prevent the middle layer from being exposed to liquid flow within the joined tubes and fittings and result in an inner surface that has almost no bead protrusion into the waterway so that the joint is acceptable for use in a high purity water system.

### BACKGROUND OF THE DISCLOSURE

High purity water (water highly purified through filtering, deionization, reverse osmosis, distillation or some combination thereof) is extensively used in research as well as in the commercial manufacture of pharmaceutical products and electronic components. Once water has been purified, it must be run through pipes that are very stable, clean and smooth, or the water will tend to become contaminated through impurities it gains from the piping materials. Over the last forty years, it has become widely recognized that thermoplastic materials are the cleanest, most stable and smoothest materials that exist to convey high purity water. In the most extreme applications, where water is purified to the greatest extent possible (a condition referred to as 18.2 mega ohm, which is the theoretical maximum resistance achievable in ultrapure water), such as in pharmaceutical or semiconductor chip manufacturing, polypropylene (PP), polyvinylidene fluoride (PVDF), and perfluoroalkoxy (PFA) materials have become the established materials of choice. This is due to the fact that these materials can be produced without pigmentation or other additives, are highly crystalline thermoplastics which can be extruded into very smooth bores, and can be joined with techniques that minimize internal imperfections in the bore of the piping.

Joining methods which produce the least internal irregularities or intrusions are preferable as any internal formations or crevices that exist can lead to stagnant areas where bacteria or other microorganisms can grow. This is very undesirable in high purity water applications, and particularly in applications where microorganisms can lead to adverse effects on the finished products or affect test results. The best joint forming techniques that have been developed to date for thermoplastic materials include a technique known as bead and crevice free butt-welding, which results in a virtually undetectable joint in the piping material. This method consists of heating the plain ends of pipes against a heating surface, and then butting the materials together while simultaneously inflating a device, a solid plug, or introducing a gas that prevents the formation of an internal bead. The only drawbacks to this method is that it is very labor intensive, is typically performed on pipes with fixed lengths (e.g. 5 meter extruded lengths and separate fittings) which require a large number of welds, and it is not possible to perform this type of welding on 100% of the joints in the system. The joints that cannot be made using bead and crevice free butt-welding (such as where a valve is located) must be accomplished via flanged connections, union connections, or other mechanical attachments.

Another method which has proven useful in high purity applications, especially when PFA tubing is involved or where the expense of bead and crevice free joining is unacceptable, is a method referred to as infrared (IR) butt fusion that uses IR radiant heat to fuse pipes and fittings together. By using radiant heat, the pipe never touches a heating surface, thus offering a purer, non-contaminated end product. In addition, the equipment which has been developed to perform infrared butt fusion is typically CNC controlled so that very careful pressures are applied for a very tightly controlled period of time, resulting in butt weld internal and external beads of reduced size and a very uniform, well rounded geometry. By comparison with traditional contact butt fusion, this reduced and uniform bead result substantially reduces the possibility that bacteria can collect and thrive at the fusion weld seam.

In the 1990's multilayer composite tubing was introduced and comprises an inner layer of thermoplastic material (such as polyethylene (PE) or cross-linked polyethylene (PEX) or PP), a malleable metallic layer such as welded aluminum or copper, and an outer layer of thermoplastic material. The inner and outer layers are typically bonded to the aluminum by means of an adhesive layer to result in a gas tight construction. Such an assembly results in tubing which can be made with thin layers for economy, yet has reasonably high-pressure ratings. In addition, the tubing is flexible due to the malleable nature of the metallic products involved, and since the inner and outer layers are relatively thin, so that the tubing can be deliverable in coiled bundles and rolled out straight. In addition, elbows can be field formed in the flexible multilayer thermoplastic tubing.

It has been recognized by the author of the present disclosure that multilayer composite tubing could also work well for high purity water piping systems if suitable joining methods can be developed. For example, the inner layer can be extruded using an unpigmented, virgin resin, such as polypropylene, PVDF, a more flexible copolymer form of PVDF (a copolymer created from monomers of vinylidene fluoride and hexafluoropropylene, sometimes referred to as Kynar Flex®, which is a tradename of Arkema, Inc.), or PFA, materials which are already readily accepted into high purity water applications. The outer layer can be offered as a pigmented product with special additives such as UV inhibitors to protect against UV attack of the pipe (a problem inherent in PP materials without additives), since the outer layer is not a wetted component. Dissimilar systems such as PVDF-AL-PP combinations can even be offered where PVDF is needed for the wetted contact layer. Such a system could be delivered into a project in long coils (e.g. 100 meter coils) and rolled out into seamless and jointless straight lengths. Further, a certain number of consecutive bends can be field formed using forming and bending tools, and flexible inserts.

What is still desired is a new and improved joint and method for joining multilayer composite tubing having at least one middle layer of malleable metal. The joint and joining method will preferably prevent the middle metal layer from being exposed to liquid flow within coupled tubes. In addition the joining method will preferably provide a joint acceptable for use in a high purity water system.

### SUMMARY OF THE DISCLOSURE

The present disclosure provides exemplary embodiments of joints and joining methods for connecting multilayer composite tubing and fittings having at least one middle layer of malleable metal. The joint and joining method of the present disclosure prevent the middle layer of malleable metal from being exposed to liquid flow within the joined tubes and fittings and result in an inner surface that has almost no bead protrusion into the fluid flow path so that the joint is acceptable for use in a high purity water system.

According to one exemplary embodiment, a joining method according to the present disclosure comprises flaring out ends of multilayer composite tubing and/or fittings to be joined so that exposed ends of the middle layer of malleable metal are directed radially outward and away from the fluid flow path within the tubing and/or fittings, and then fusing the flared out ends using infrared butt welding so that the resulting bead protrusion into the fluid flow path is small enough to be acceptable for use in a high purity water system.

According to one aspect, the ends are flared outwardly such that a small radius at the wetted base of the flare is achieved so that fusion weld beads occupy the space created by the radius, and thereby result in an inner surface that has almost no bead protrusion into the waterway. The flared ends, therefore, make the resulting joint even more acceptable than standard infrared butt fusion welds, which are already widely accepted by the industry.

The middle layer of malleable metal incorporated into a flared end formed in accordance with the present disclosure would act to reinforce the joint, as well as provide a heat sink to allow the wetted surfaces to be thoroughly and uniformly fused together. The middle layer of malleable metal will also act to prevent problems associated with creep of the thermoplastics, thereby minimizing future potential failures due to creep at the joints.

Unlike contact butt fusion, and in traditional infrared butt fusion, fusion in accordance with the present disclosure does not occur at the ends of the pipe surface, but rather is being made at flat flange faces that are at a right angle to the flow. Since these small flat faces are produced by flaring material that originates from the inside diameter of the pipe, the material is clean, and will be highly regular in surface shape, and will not need to be subjected to shaving or planning using a rotating cutting or planning tool (a standard step in contact or normal infrared butt fusion). This means that another major potential source of impurity is eliminated whereby metal fragments can be introduced or imbedded into the pipe due to contact with the cutting tools. This feature also serves to make the joints produced from the modified infrared method in this disclosure even cleaner and even more desirable than those produced by traditional infrared butt fusion.

It is apparent that the joining methods and the resulting joints provided in accordance with the present disclosure have many advantages over previous high purity systems. For example, the presently disclosed joint and joining method makes multilayer composite tubing more practical so that the use of coiled tubes in long lengths that can be rolled out in rigid fashion, together with the field formability of many of the elbows, will eliminate 70 to 90 percent of the joints found in previous high purity systems. Where fusion joints are required, the presently disclosed joint and joining method provides joints having smaller beads joint and less potential for contamination.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference character designations represent like elements throughout, and wherein:

FIG. 1 is an end sectional view of a multilayer composite tube;

FIG. 2 is a side sectional view of a flared end flange face that has been formed on the multilayer composite tube of FIG. 1 in accordance with the present disclosure;

FIG. 3 is a side sectional view of the flared end flange face of FIG. 2 being formed using a single-sided mandrel in accordance with one exemplary embodiment of the present disclosure;

FIG. 3A is a side sectional view of two of the flared end flange faces of FIG. 2 being formed using a double-sided mandrel in accordance with another exemplary embodiment of the present disclosure;

FIG. 4 is a side sectional view of two of the flared end flange faces of FIG. 2 shown positioned in an infrared butt welding tool in accordance with an additional exemplary embodiment of the present disclosure;

FIG. 5A is a side sectional view of the two flared end flange faces of FIG. 4 joined together after being melted and clamped in the infrared butt welding tool in accordance with the present disclosure;

FIG. 5 is a side sectional view of the two flared end flange faces of FIG. 4 joined together after being removed from the infrared butt welding tool in accordance with the present disclosure;

FIG. 6 is an illustration showing an exemplary embodiment of an infrared heating element of the infrared butt welding tool of FIGS. 4 and 5A; and

FIG. 7 shows a cross section of a finished joint where a multilayer tube constructed in accordance with the present disclosure is joined to a fitting, such as a tee fitting.

### DETAILED DESCRIPTION OF EXEMPLARY EMBODIMENTS

The present disclosure overcomes many of the prior art problems with joints and joining of high purity water tubing and piping systems. In general, the joints and joining methods are used to create extensive yet highly sanitary plumbing networks. Among other features and benefits, the disclosed joints and joining methods facilitate high quality and strong joints and can create complex networks of piping. The advantages and other features disclosed herein, will become more readily apparent to those having ordinary skills in the art from the following detailed description of exemplary embodiments taken in conjunction with the drawings which set forth representative embodiments of the present disclosure and wherein like reference numerals identify similar structural elements.

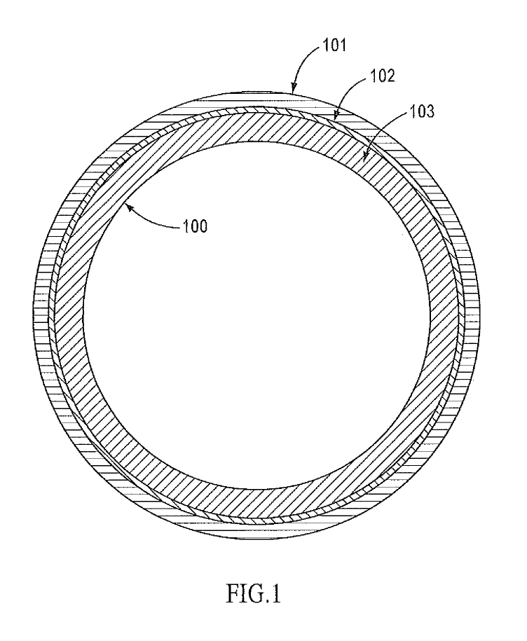

All relative descriptions herein such as upward, downward, left, right, up, down, length height, width, thickness, and the like with reference to the Figures are not meant in a limiting sense. Additionally, the illustrated embodiments can be understood as providing exemplary features of varying detail of certain embodiments, and therefore, features, components, modules, elements, and/or aspects of the illustrations can be otherwise combined, intersected, sequenced, separated, interchanged, positioned, and/or rearranged without materially departing from the disclosed joints or joining methods. Additionally, the shapes or sizes of certain components are also exemplary and can be altered without materially affecting or limiting the disclosed joint and joining method. Referring first to FIG. 1, there is shown a cross sectional view of a multilayer composite tube 100, which in the exemplary embodiment shown includes five layers. This five layer construction consists of an inner layer 103 of extruded thermoplastic material, consisting of a material like PFA (perfluoroalkoxyalkane polymer), PVDF (polyvinylidene fluoride), VF2-HFP copolymer (a copolymer of vinylidene fluoride and hexafluoroprylene monomers), PP (polypropylene copolymer or homopolymer), HDPE (high density polyethylene), PE100 (bimodal resin consisting of ultra high molecular weight polyethylene and linear low density polyethylene), or PEX (cross linked polyethylene). The inner layer 103 is preferably manufactured from an unpigmented form of one of these resins when the multilayer pipe 100 is being used for the transport of high purity water of other high purity substances.

Although not viewable in FIG. 1, the five layers include an adhesive layer provided on the exterior of the inner layer 103. A layer 102 of malleable metal, such as aluminum or copper, is formed around the adhesive layer provided on the exterior of the inner layer 103. The malleable metal layer 102 is formed, for example, by means of welding using laser welding techniques, which results in a very uniform layer. Surrounding the middle malleable layer 102 is a fourth layer, not viewable in FIG. 1, which is another application of adhesive.

The outer fifth layer 101 is also an extruded thermoplastic, which can be from among one of the same resins described above. The outer layer 101 may be a pigmented material which has additives that protect or inhibit against the harmful effects of ultraviolet light, which is particularly important when using a material such as PP, HDPE, PE100 or PEX, each of which are affected to some degree by UV light. The resin used to manufacture the outer layer 101 may also have any number of additional additives such as flame retardants, smoke suppressants, impact modifiers or other additives to achieve fire resistance or other desirable performance characteristics such as impact resistance, etc. In this manner, the inner layer 103 has the best form of the material to maintain purity, while the outer layer 101 has the best protection of the multilayer pipe 100 against external ambient effects. Also, the inner layer 103 can be one material and the outer layer 101 can be a dissimilar material. In this manner, an expensive material such as PFA or PVDF can be used as the inner layer 103 and the outer layer 101 can be a less expensive material such as PP or HDPE, thereby making the entire assembly 100 an economical overall combination while preserving the performance characteristics of the inner most layer 103. As a result, the entire assembly 100 can be less expensive than a solid pipe of extruded thermoplastic material of typical thicknesses produced to handle the same class of service for a comparable diameter size.

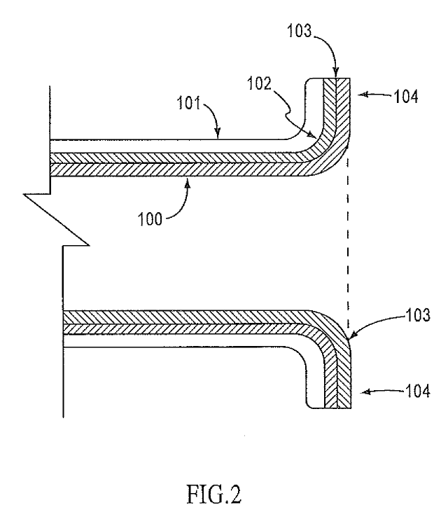

Referring now to FIG. 2, an end of the tube has been flared into a small flange-shaped flare configuration 104. The size of the flare 104 is preferably limited in size to that which is necessary to result in a butt weld joint of adequate strength. It is not necessary to make the flare 104 any larger than the minimum required, as the larger the flare 104 produced, the greater the risk that the middle malleable layer 102 will be cracked or compromised in the process. Note that as the result of forming the end of the multilayer tube 100 into the flange-shaped flare 104, a clean section of the inner layer 103 is now exposed and is perpendicular to the direction of fluid flow through the multilayer tube 100. This is an important characteristic to enable butt weld joints of high quality to be made, without having to plane or shave the surface.

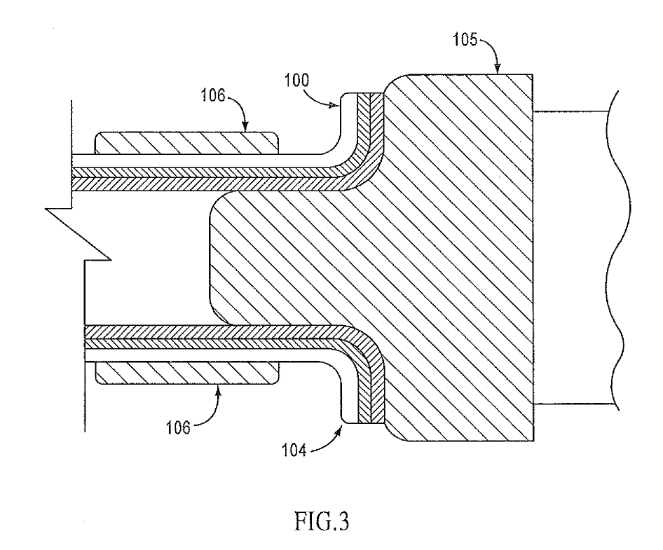

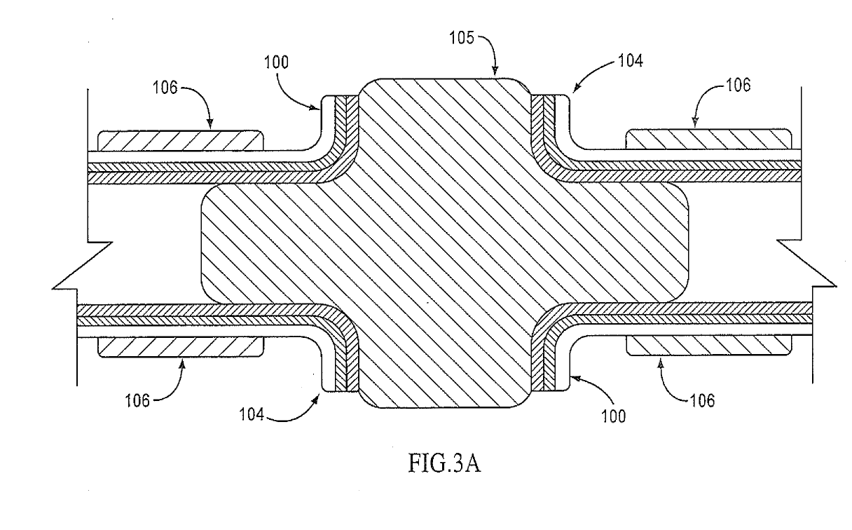

In FIG. 3, an exemplary embodiment of a mandrel 105, which produces the flare 104, is shown. The mandrel 105 is preferably made out of a hard material such as steel, stainless steel, or ceramic. If the mandrel material is a metal, it should be coated with a tough, resilient high purity material such as ceramic, or a durable form of a fluoropolymer such as PTFE, FEP, PFA, or PVDF. The mandrel 105 can be mounted into a hand tool, or it can be mounted onto a bench top tool. The bench top tool can also serve as the same tool used to perform the butt-welding procedure. Regardless of whether the tool is hand held, or a bench tool, it is necessary to clamp the multilayer pipe 100 using an external clamp 106 and force it into the mandrel 105 in order to produce the flare. It is not necessary in most circumstances to first heat the end of the multilayer tube 100 since the flare 104 is relatively small in size. However, the mandrel 105 may be required to have several tapered steps or stages in its design, resulting in a longer mandrel that produces the flare 104 one step at a time so as not to cause the middle malleable metal layer 102 to split or crack. The mandrel 105 shown is a simple one step mandrel. However, it is understood that the mandrel could be more complex in shape, with multiple tapers.

FIG. 3A shows a variation of FIG. 3, where the mandrel 105 is two sided, so as to enable the flaring of multilayer tubes 100 on either side into the flared flange-shape 104. This could either be done simultaneously, or one at a time.

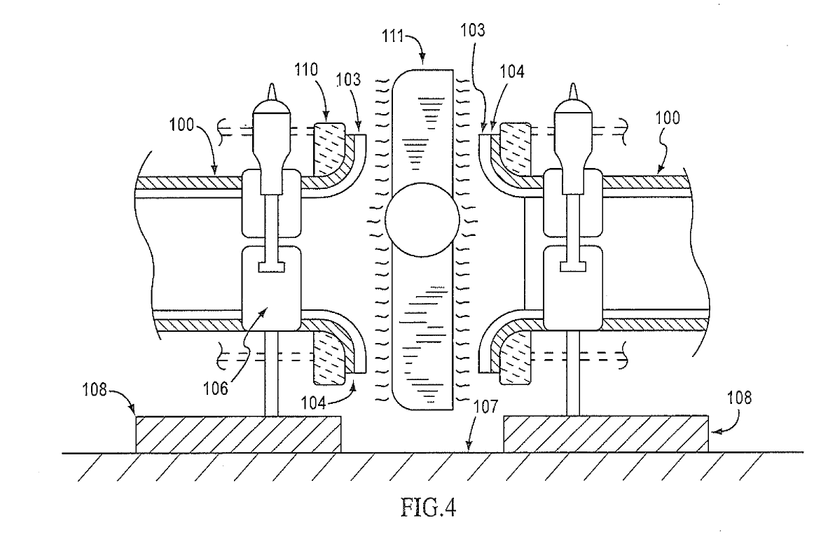

Referring now to FIG. 4, sections of multilayer tubes 100 having flared ends 104 already formed into the tube ends are shown mounted into a butt fusion tool 107. The butt fusion tool 107 is manufactured to have a flat surface with one stationary bed 108. The multilayer tubes 100, having the already produced small flanged-shaped flared ends 104 are clamped into the stationary and moving beds 108 and 109, respectively, using a clamp 106. The clamp 106 may be the same set of clamps used to produce the flare 104 in the flaring step, especially if the butt fusion tool 107 also is used to produce the flares 104 as well as to accomplish the butt fusion. To accomplish the heating of the ends of the pipes, an infrared heating mirror 111 is used, which is positioned in the middle of the two adjacent flared ends 104 of the tubes 100, and at a short distance of ¼ inch (6 mm) or more from the flat surface of either tube. The heating mirror is powered by infrared heating elements that allow the heating mirror to achieve a temperature of between 1250° F. to 2000° F., and thereby enabling the heating to take place by means of radiation to the flat surfaces of the exposed inner thermoplastic material 103. While heating by means of radiation via an infrared source is preferred due to eliminating the need to contact the surface, it is also understood that heating can also take place by means of traditional contact-type butt fusion through direct conduction, where contact can be tolerated.

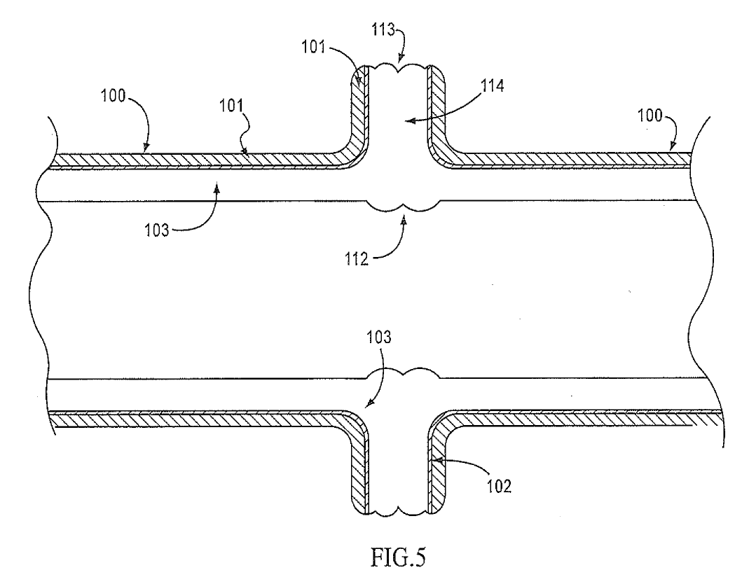

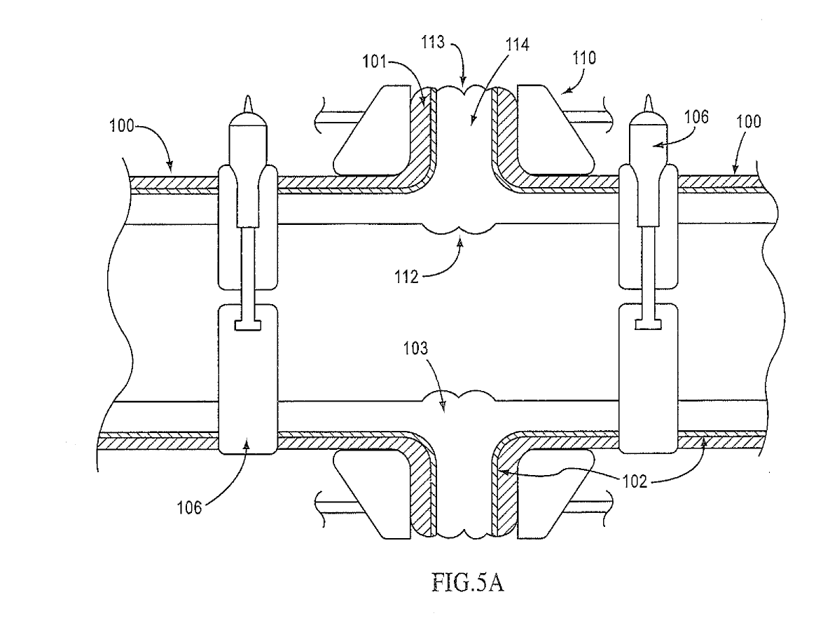

In FIG. 4, an optional external clamp 110 is indicated. The external clamp is in place so as to prevent the outer thermoplastic material 101 from move outward when the two tubes 100 are brought together under pressure after the flared ends 104 have been heated and the heating element 111 is removed. This will allow an external bead to form properly at the outer edge of the joint, which will fully cover the malleable middle layer 102 in the finished joint, which is shown and described in FIGS. 5A and 5B.

Referring now to FIG. 5A, the joined parts as shown after the flared ends 104 of the adjacent tubes 100 are brought together under pressure. The weld seam is indicated by 114 and consists of mostly the inner thermoplastic material 103 of both multilayer tubes 100 uniformly mixed together. These molten inner thermoplastic materials 103 will eventually recrystallize into a unitary homogeneous bond once they reach the temperatures to which the thermoplastic materials turn solid. In the finished joint, there is a small weld seam 112 at the inner waterway or flow path, which protrudes slightly into the waterway and restricts the water flow only to a minor degree. The protrusion is so small because the flare ends 104 are rounded, which creates a natural pocket with which to receive molten material, thereby restricting the development of bead size to a great degree. There is also a small, relatively uniform rounded weld seam 113 that forms at the outer edge of the joint. This weld seam 113 consists of materials from both the outer material 101 and the inner material 103 of the multilayer tubes 100 from each adjacent multilayer tube 100. Note that the middle malleable metal layer 102 of each tube is both sealed off completely from the inner fluid, and also sealed off to a great degree, or even entirely from the outside atmosphere as well. In FIG. 5, the finalized joint is shown after it has been removed from the butt fusion tool.

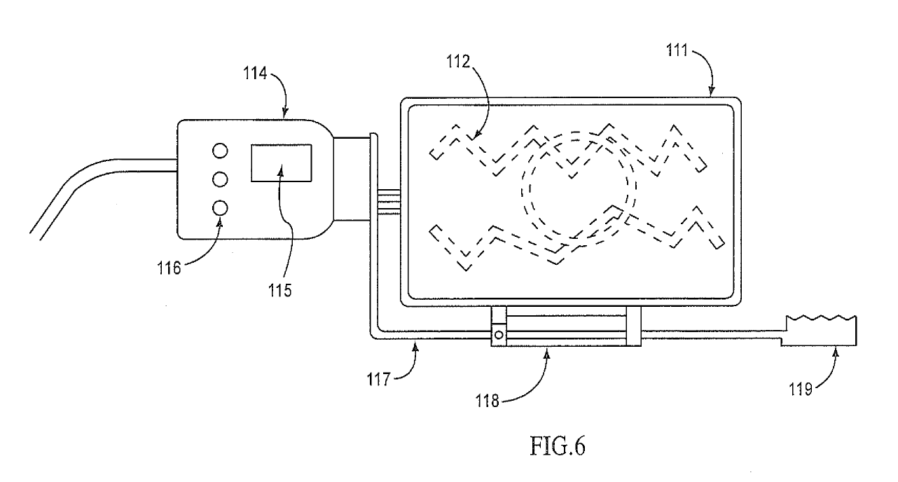

Referring now to FIG. 6, the illustration shows a side view of the infrared heating element 111. The heating element 111 can be constructed with flat surfaces of a material type that when heated can glow and emit heat via light in the infrared range from its flat surfaces. The heater element may be constructed of ceramic or may be a quartz heater with electric heating elements 112 embedded in the surface of the heater. The temperature at the surfaces of the heater may vary but it has been found that temperatures produced in the range of 1250° F. to 2000° F. are successful. The heating element 111 has a handle 114, and is equipped with an LCD or other display 115 that can indicate the temperature at the surface of the heating element. The heating element's handle 114 also contains various switches and indicator lights 116 to turn the unit on and off, as well as to indicate when it the unit is ready to perform the fusion. Other controls will also be available on the base of the butt fusion tool 107 to perform the other tasks of the tool such as fixing the proper distance of the flared ends 104 from the surface of the tool, the insertion and later removal of the heating element, the time of fusion, and the speed with which contact is made, the pressure of fusion, and the cool down period. The heating element 111 also is equipped with a frame 117 that is positioned within a slide opening 118 on the base of the heating element. This frame is designed so that the tool can either be controlled manually with a handle 119, or can alternatively be mounted directly onto the butt fusion tool to be automatically controlled by the microprocessor based butt fusion tool.

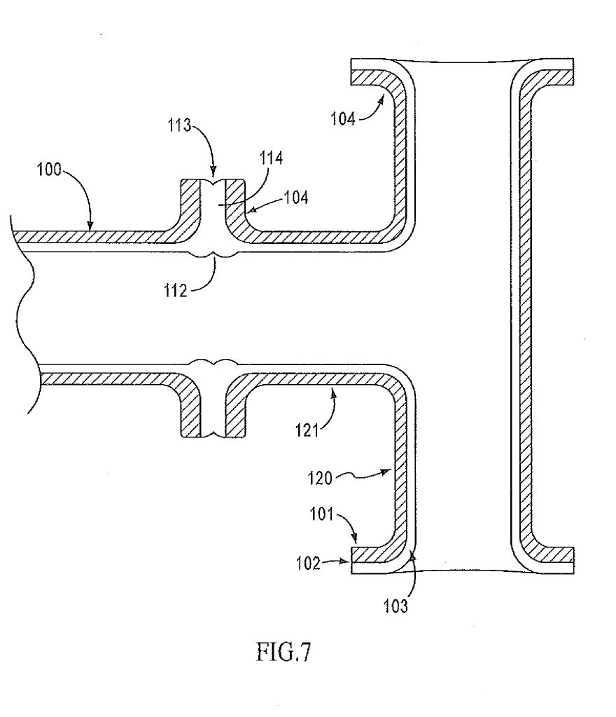

FIG. 7 shows a finished joint where a multilayer tube 100 is joined to a fitting 120, which in this case is shown to be a tee fitting. It is understood that the fitting could also be an elbow, valve, adapter, reducer, or other type of fitting. The fitting is manufactured to also be of similar construction to the multilayer tubes, such that it also has an inner layer 103, middle malleable layer 102 and an outer layer 101 of matching construction to the tube, and also has integrally formed flared ends 104 of matching shape and size to those of the tubes. The necks of the fitting 121 are such that they are long enough to accommodate insertion into the butt fusion tool.

Thus, the present disclosure provides a new and improved joint and method of joining multilayer composite tubing. It should be understood, however, that the exemplary embodiments described in this specification have been presented by way of illustration rather than limitation, and various modifications, combinations and substitutions may be effected by those skilled in the art without departure either in spirit or scope from this disclosure in its broader aspects and as set forth in the appended claims. Accordingly, other embodiments are within the scope of the following claims. In addition, the improved joint and method of joining disclosed herein, and all elements thereof, are contained within the scope of at least one of the following claims. No elements of the presently disclosed joint and method of joining are meant to be disclaimed.

What is claimed is:

1. A tubing assembly comprising:
a) elongated first and second tubes for carrying a fluid flow,
each tube being a composite tube having at least an inner layer, a middle layer surrounding the inner layer, and an outer layer surrounding the middle layer, and
each tube having an end, wherein the ends are flared radially outward from an axis of the tubes in complimentary shapes with the middle layer being directed away from the fluid flow and following a contour of the inner layer; and
b) unitary homogeneous bond formed between the inner layers of the flared ends.

2. A tubing assembly as recited in claim 1, wherein each tube has five-layers.

3. A tubing assembly as recited in claim 2, wherein the five-layers include: the inner layer; a first adhesive layer provided on an exterior of the inner layer; the middle layer of malleable metal; a second adhesive layer provided on the exterior of the middle layer; and the outer layer.

4. A tubing assembly as recited in claim 1, wherein the inner and outer layers are extruded thermoplastic.

5. A tubing assembly as recited in claim 1, wherein the inner layer is a different material than the outer layer.

6. A tubing assembly as recited in claim 1, wherein the ends are formed perpendicularly away from an axial length of the tubes.

7. A tubing assembly as recited in claim 1, wherein one of the first and the second tubes comprises a fitting.

8. A method for joining multilayer tubes, the tubes having an inner layer, a middle layer surrounding the inner layer, and an outer layer surrounding the middle layer, the method comprising the steps of:
creating a flange on an end of the first and second multilayer tubes by flaring the inner layer of the multilayer tubes outward; and
fusing the inner layers of the flanges of the first and second multilayer tubes.

9. A method as recited in claim 8, wherein the middle layer follows a contour of the inner layer.

10. A method as recited in claim 8, wherein the inner layers of the flanges of the first and second multilayer tubes are fused using an infrared heating element.

11. A method as recited in claim 8, wherein the flanges are created using a mandrel.

12. A fitting for quick and sanitary connection comprising:
a central portion of multilayer composite;
a first end extending from the central portion; and
a second end extending from the central portion,
wherein at least one of the ends is flared approximately perpendicularly away from an axial length of the central portion to prevent a middle layer of the multilayer composite from contacting fluid passing through the fitting.

13. A fitting as recited in claim 12, wherein the central portion is an elbow.

14. A fitting as recited in claim 12, wherein the central portion is a Tee.
